(19) United States
(12) Patent Application Publication
(10) Pub. No.: US 2006/0253478 A1
(43) Pub. Date: Nov. 9, 2006

(54) Client centric document preparation interface

(76) Inventors: Michael L. Graham, Dallas, TX (US); Christine Madsen, Olympia, WA (US); Patricia A. McLelland, Spark, MD (US)

Correspondence Address: CARSTENS & CAHOON, LLP, P O BOX 802334, DALLAS, TX, 75380, US

(21) Appl. No.: 11/377,317

(22) Filed: Mar. 16, 2006

Related U.S. Application Data
(60) Provisional application No. 60/662,420, filed on Mar. 16, 2005.

(51) Int. Cl. G06F 7/00

(52) U.S. Cl. 707/100

(57) ABSTRACT

A system and method allows multiple users to more efficiently access and use client information in the preparation and assembly of documents. A computer software system captures certain information from clients and separately stores it from ordinary document assembly files such as template and answer files. A computer software system provides an intuitive, friendly environment in which to call a document assembly engine. A computer software system enables a more efficient re-use of information to form completed documents. A context-sensitive computer software interface hierarchally arranges a list of documents by client, then client matter, and then document type. Files are internally uniquely named and are accessed by a checkout mechanism from a central repository which avoids data loss associated with multi-user access.

### CROSS-REFERENCE TO RELATED APPLICATION

This application claims the benefit of and priority to a U.S. Provisional Patent Application No. 60/662,420 filed Mar. 16, 2005, the technical disclosure of which is hereby incorporated herein by reference.

### BACKGROUND

1. Technical Field

This invention relates to a system and method for managing the workflow in a professional workplace, and more particularly pertains to a method and system for collecting, maintaining and using client data. Such method and system provide a means to more efficiently gather, catalog, and store client and other types of information and facilitate the more efficient preparation of documents. Users may use the system and method to interface with software applications such as document assembly engines and databases. Users spend more time productively engaging their business expertise and exploiting their skills, and less time finding and using shared information.

2. Description of Related Art

Many businesses use templates, ones which may contain reusable boiler-plate, recycled or frequently used language. Computers facilitate producing, editing, transmitting, and printing of templates. Law firms, businesses, real estate firms, insurance companies, and others often use such templates in litigation, real estate closings, and claim handling. Forms are often arranged electronically according to task.

Templates are readily available in both printed and electronic form (e.g., Adobe portable document format files, Microsoft Word files, Corel WordPerfect files). Similarly, legal document-generating software is commercially available (e.g., LexisNexis HotDocs®), Innovative Software Products of Virginia Pathagoras, Keylogix ActiveDocs). However, the prior art does not capture all of the increased efficiency possible through effective re-use of client and other types of information. Typically, users start from templates and pre-existing blocks of text to assemble documents. According to the prior art, documents are assembled by filling in templates with task-specific and client-specific language. This order of adding information is inefficient, especially since client information is usually last to be considered as part of a task to create a document.

FIG. 1 illustrates a typical document assembly process according to the prior art. With reference to FIG. 1, a user starts 102 the document assembly process by choosing a document class 104. Next, a user selects a specific document template 106 before assembling a document 110, for example, a pourover will. The user subsequently enters all relevant information 108. Next, the user provides a filename and path to the document and answer file 110. The user then initiates an assembly process 112 and, in the last step, has an opportunity to review and print an assembled document 114 before ending the process 116. When a user requires a subsequent document, the process shown in FIG. 1 is repeated. The efficiency in the prior art is in the re-use of pre-existing language found in document templates corresponding to step 106. However, client information must be re-entered each time a document is generated.

For example, if a user wishes to create a trust for an existing client, a user might hierarchally select “legal document,” “estate planning,” and finally “trust” before a template having blanks or a set of blocks of text are presented to the user. Once a document is formed, it often has blanks or empty fields for client information. At this point, a user re-enters client information which is likely already stored in the same computer system such as in other saved answer files or documents previously prepared for a client. There does not exist in the prior art a method or apparatus for capturing and efficiently re-using client information from one document to the next. For example, there is no efficient mechanism for creating a reciprocal or “mirror image” document for a spouse using the same basic answers found in a previously created client record.

Certain patents have disclosed concepts associated with assembling documents, but none meet the needs filled by the present invention. For example, U.S. Pat. No. 5,446,653 issued Aug. 29, 1995 to Miller et al, describes a document generation system that separately stores all paragraphs that might be used in creating an insurance policy document. A policy form is primarily a list of references to the paragraphs that may be included in a policy document. The document generation system merges necessary paragraphs into a policy document as it creates the document. A user supplies the system with data that the system needs to determine which paragraphs are to be included in the document. Thereafter, when creating the document, the system invokes a set of rules by which it determines from the input data which paragraphs are to be included in the document. However, patent '653 does not re-use client information when assembling subsequent documents, especially for the same client as disclosed in the present invention.

U.S. Pat. No. 5,729,751 issued Mar. 17, 1998 to Schoolcraft describes an interactive document assembly system in which codes are embedded in a form at points where a decision must be made as to whether to include or delete a clause, insert a variable field or make a word choice. Each code value is associated with a set of instructions stored in an instruction database. When creating a document, the system sequences through the form, and whenever it encounters a code it obtains and executes the instructions associated with the code. Since the questions are asked in the order of occurrence as the system scans through a form, the system is not easily adapted for use with user-friendly data entry screens. While such a document generation system is flexible, a system capable of producing a large number of complex documents could require hundreds of such codes. Programmers would find it difficult to update and maintain such a system without duplicating the content codes. Further, there is not an efficient re-use of client information when assembling a document as disclosed in the present invention.

U.S. Pat. No. 5,893,914 issued Apr. 13, 1999 to Clapp discloses an interactive computerized document assembly system including a model template formed of a sequence of sections and having decisional options including clause repeats, conditional clauses, and questions to be answered, after which a document is assembled. Patent '914 also describes functions for indicating the location in the model template for the decisional options to identify the sequence of sections constituting the model template. A video displays a portion of the template, and an answer index stores answers to questions posed in the portion of the template displayed, each of the questions having a unique identifier. Patent '914 discloses the merging, with each displayed section or part thereof, the answers corresponding to each displayed section or part thereof. Patent '914 also discloses the combination and redisplay in sequence of each merged section or part thereof in order to assemble a document from the model template. However, patent '914 does not store and efficiently re-use client information from one document to another.

U.S. Pat. No. 6,366,892 issued Apr. 2, 2002 to Altman, et al. discloses a method and system for automatically generating customized legal documents, particularly for institutional commercial loans, from a database of loan provisions including standard clauses and alternate optional clauses for each of the standard clauses. The prospective borrower selects either a standard clause or one or more optional clauses for different loan provisions. A value is assigned to each of the optional clauses and the cost of the loan is determined and based on the clauses selected by the prospective borrower. However, patent '892 does not store, arrange and use client data in a client-centric fashion when assembling documents. If multiple loan documents were to be generated for one particular client, the same client information would have to be entered separately into each form.

U.S. Pat. No. 6,473,892 issued Oct. 29, 2002 to Porter discloses a document assembly system which prints one or more documents in response to input data describing the nature and circumstances of a transaction to be documented and describing the parties to the transaction. The document assembly system initially produces a separate document definition object for each document to be produced, and a separate party definition object for each party to the transaction. The party definition object includes procedures for generating party-related text that the document is to use when referring to a party. The nature of the text each document definition or party definition object procedure produces depends on the nature of the document or the party as indicated by the input data. The system also includes a set of “text generators,” which are blocks of source code, that when compiled and executed, generate the text that may be included in a document. When the nature of a word or phrase to be included in a document depends on the nature of the document or on the nature of a party, the text generator refers to the word or phrase by referring to a procedure of the document or party definition object which generates the word or phrase. Even though patent '892 stores party information, party or user data for assembling documents is not efficiently re-used as disclosed in the present invention. Further, patent '892 does not disclose arranging and organizing document assembly in a client centric manner. Further, patent '892 does not provide for a client centric interface when a user assembles a document.

U.S. Pat. No. 6,694,315 issued Feb. 17, 2004 to Grow discloses an online document assembly and docketing method using a user workstation interconnected over a network backbone to a website (i.e., an application server). First, a new user stores identification information in a user table. The user inputs identification information at the user workstation which is received at the website. An assembled document is generated by accessing a template from the form table at the website and inserting stored case data, which has also been previously entered and stored in the application server, into a “form document” or template. The assembled document is then delivered to the user workstation over the network backbone. However, patent '315 does not store, use and arrange user identification and other types of client data in a client-centric fashion when assembling documents as disclosed in the present invention.

Therefore, a need exists to better utilize previously captured client information, such as, but not limited to, a client's name, contact information, financial assets, business information, and an historical account of pertinent facts. A need exists to provide an interface to a system whereby a user can assemble a document in a client centric fashion instead of a traditional task centric fashion. A need exists to enable a user to quickly copy a correct answer set then re-use it to create a second document for the same or related individual.

Further, a need exists to manage the workflow of information in a professional setting. A need exists to provide a friendly graphical user interface requiring little or no training. A need exists to provide security over client information. A need exists to provide multi-user access, file locking, and database locking to prevent data loss and corruption of client information. A need exists for managing software licenses of applications and modules for such client centric software. A need exists for providing backup and restore functions of client information, not just client documents. A need exists to provide a more elegant software mechanism to retrieve and use client information than currently available in the prior art.

### SUMMARY OF THE INVENTION

The object of the present invention is to more efficiently use existing client information in the preparation of documents. Certain information from clients is captured in a computer system and is stored separately from ordinary document assembly files such as template and document answer files. A document assembly engine is called and used to more efficiently combine and re-use information to form completed documents.

Through the use of an intuitive context-sensitive computer software interface, documents are organized in a hierarchal fashion according to client, then matter, and finally in a listing of the documents generated for that client/matter. This hierarchy more closely matches the workflow paradigm of businesses. A template manager organizes the system's legal templates in a hierarchal fashion and links each template to a specific pattern answer file which provides default answers during a document interview process. A template manager also allows users to select correct templates and pattern or answer files which are subsequently merged to form assembled documents.

A GUID naming convention allows the invention to internally create and track document and answer files so that stored information is not lost while allowing users to give intuitive names and context to their documents. The invention preferably stores information and documents in a central repository. The invention provides a means whereby a document may be accessed by only a single user at any one time. Such means prevents the loss of information when multiple users work with one document. At the same time, the invention allows multiple users to efficiently access and re-use client and other information. Security, license and preference modules facilitate the granting of access rights to individual users and to maintain user and group preferences. The software interface provides context sensitive information to aid a user in working with document assembly and in re-using information.

The invention accordingly comprises the features described more fully below, and the scope of the invention will be indicated in the claims. The objects of the present invention will become apparent in the following detailed description.

### BRIEF DESCRIPTION OF THE DRAWINGS

The novel features believed characteristic of the invention are set forth in the appended claims. The invention itself, however, as well as a preferred mode of use, further objectives and advantages thereof, will be best understood by reference to the following detailed description of illustrative embodiments when read in conjunction with the accompanying drawings, wherein:

FIG. 1 is a flow chart showing document assembly according to the prior art;

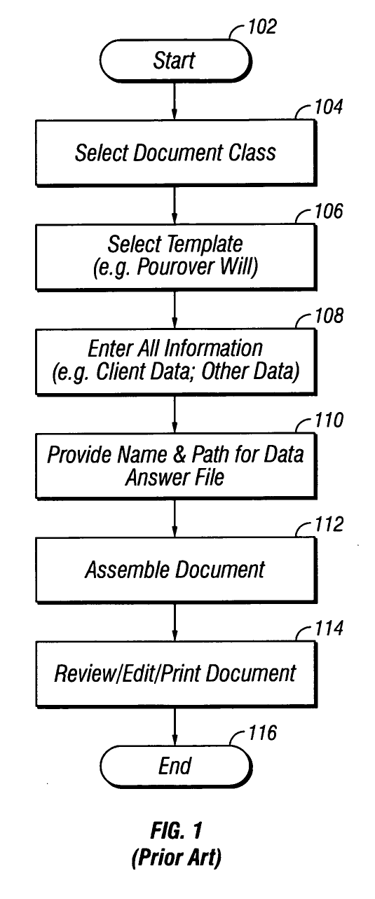

FIG. 2 is a flow chart showing one method of document assembly according to the present invention;

FIG. 3 is an exemplary software form according to one embodiment of the present invention showing login security;

FIG. 4 is an exemplary software form according to one embodiment of the present invention showing the main user interface wherein document generation is hierarchally based around a client record and which corresponds to step 206 of FIG. 2;

FIG. 5 is an exemplary software form according to one embodiment of the present invention showing a preferences interview corresponding to step 208 of FIG. 2;

FIG. 6 is an exemplary software form according to one embodiment of the present invention showing an add client dialog corresponding to step 210 of FIG. 2;

FIG. 7 is an exemplary software form according to one embodiment of the present invention showing a client interview corresponding to step 212 of FIG. 2 wherein client metadata can be captured in a proprietary database;

FIG. 8 is an exemplary software form according to one embodiment of the present invention showing an add matter dialog corresponding to step 214 of FIG. 2;

FIG. 9 is an exemplary software form according to one embodiment of the present invention showing a matter interview corresponding to step 216 of FIG. 2 wherein matter metadata can be captured in a proprietary database;

FIG. 10 is an exemplary software form according to one embodiment of the present invention showing an add document dialog corresponding to step 218 of FIG. 2 wherein a document type or template is selected;

FIG. 11 is an exemplary software form according to one embodiment of the present invention showing a document interview corresponding to step 220 of FIG. 2 wherein document class metadata can be captured in a proprietary database;

FIG. 12 is an exemplary software form according to one embodiment of the present invention similar to FIG. 4 showing selection of a document assembly function corresponding to step 222 of FIG. 2;

FIG. 13 is an exemplary software form according to one embodiment of the present invention showing a resource manager;

FIG. 14 is an exemplary software form according to one embodiment of the present invention showing a preferences manager;

FIG. 15 is an exemplary software form according to one embodiment of the present invention showing a firm settings manager;

FIG. 16 is an exemplary software form according to one embodiment of the present invention showing a help manager;

FIG. 17 is an exemplary software form according to one embodiment of the present invention showing a license manager;

FIG. 18 is an exemplary software form according to one embodiment of the present invention showing an administration manager;

FIG. 19 is an exemplary software form of an administration manager according to one embodiment of the present invention showing how a software user may be added to the software application;

FIG. 20 is an exemplary software form of an administration manager according to one embodiment of the present invention showing how a software user may be assigned rights to a practice system; and,

FIG. 21 is an exemplary software form according to one embodiment of the present invention showing a customization manager.

### DETAILED DESCRIPTION

While the invention is described below with respect to a preferred embodiment, other embodiments are possible. The concepts disclosed herein apply equally to other systems and methods which gather and organize client information, and assemble documents in a client centric fashion. Furthermore, the concepts applied herein apply more generally to the management and use of client information. The invention is described below with reference to the accompanying figures.

### DEFINITIONS

A template as used herein, is defined as a generic document preferably having form fields such that specific information can be placed therein. Templates are generic in that no client specific data is included, but text common to any similar document is included. Templates can also include sample or instructional text (e.g., <insert first interrogatory here>). Throughout this document, text within angled brackets (“<” and “>”) is user defined, and the exact content of such text is immaterial to the functioning of the invention. Preferably, the templates are formatted in conventionally available word processor formats (e.g., Microsoft Word, Corel WordPerfect, rich text format, ASCII text) so that the templates can be readily edited by a user after being assembled. It is to be understood that any number of template fields can be used and will be limited only by the various documents necessary for a given case.

An assembled document, as used herein, is defined as a template that has been combined with specific client and other information. Preferably, the assembled document contains text specific to the given client and task, and where text may be added automatically by the software system. Information may be taken from answer files.

The present invention may be implemented and practiced with a conventional personal computer system having a CPU, storage device, keyboard, mouse and monitor. As used herein, a user is defined as any operator of such personal computer. In one example, the user is an attorney or member of a law firm staff. This example is used throughout the description. It will be understood by those in the art that the application may be practiced by anyone.

It is to be understood that each personal computer can have individual internal memory. Likewise, internal memory can be random access memory (RAM), read only memory (ROM), any suitable form of storage disk (e.g., magnetic tape, hard disk, floppy disk, ZIP disk, etc.), or any combination thereof. Furthermore, the memory can be a single memory or separate memories, and can reside within the host computer or independently thereof.

Architecture

One embodiment of the present invention assembles a document from templates merged with client data. The detailed assembly of documents is done by a third-party document assembly software engine. In a preferred embodiment, HotDocs® (Matthew Bender & Company Inc., part of the LexisNexis Group, Albany, N.Y.) is used. However, other document assembly software applications may be used.

HotDocs® provides a means to gather, organize, and maintain client, matter, document and other information through “interviews.” An interview as used herein is a series of software forms which prompt and guide a user through the process of storing information. Interviews may consist of software calls through a published API to one or more other third-party software programs. Interviews and interview forms may be conducted using software forms generated by the present invention or generated by third-party software applications. During the time a third-party software interview is open, the present invention transitions from an “active state” to a “wait state.” Upon completion of a third-party software interview, the present invention signals the third-party software to close, whereupon the present invention transitions back to an active state.

HotDocs® also provides a means for maintaining templates which hold the text and rules for assembling a custom output such as an assembled document. In one embodiment, a run-time version of HotDocs®, known as the HD Player, is delivered along with other software components comprising the present invention. The software system utilizes the HD Player through published software API calls. The software system runs interviews, overlays the data from multiple files into a matter file for each matter, and assembles documents.

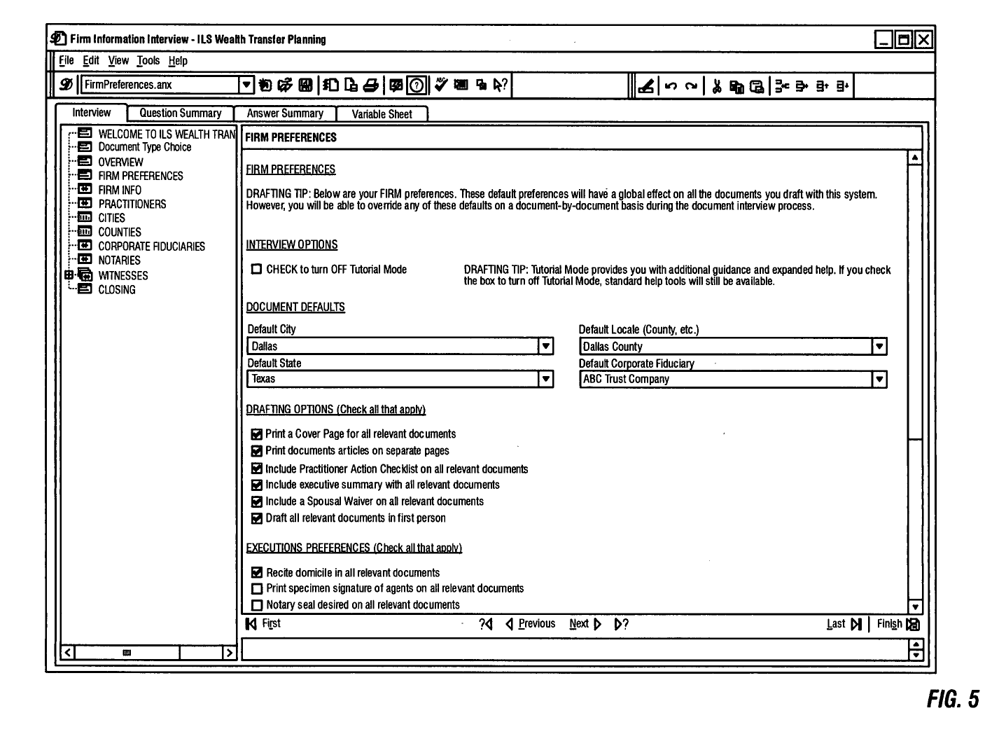

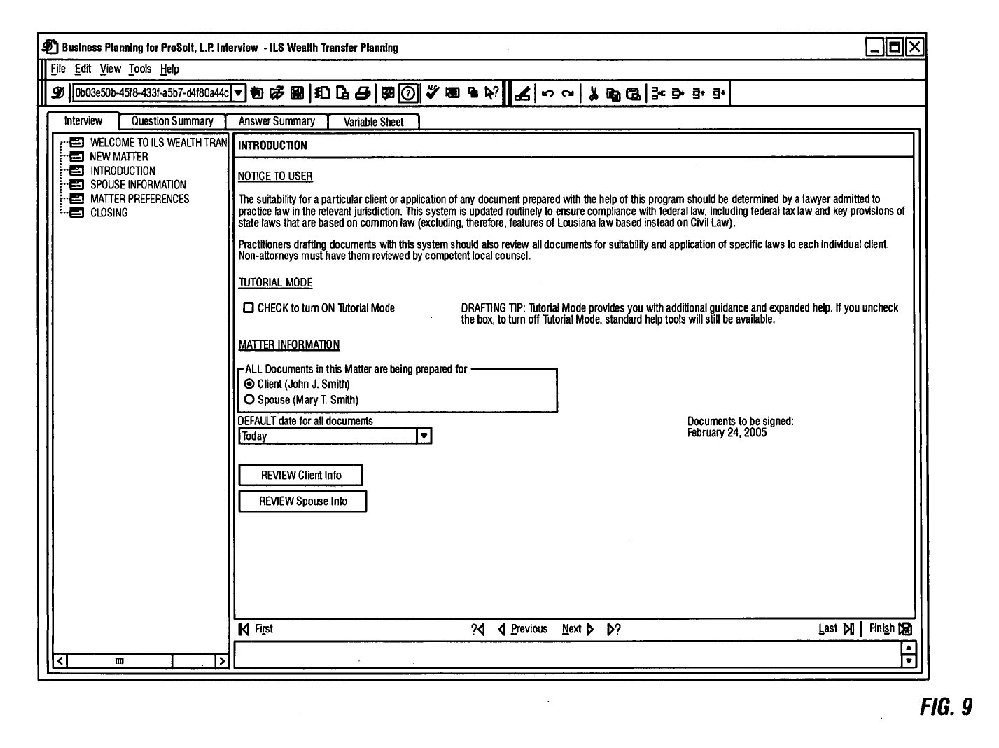

FIG. 5 exemplifies a general embodiment of calling a HotDocs® interview using a published API call and specifically shows a firm preferences interview. This third-party software interview is used to prompt a user for additional information. FIG. 9 illustrates a similar interview to gather matter information which may be stored by the present invention in <matter>.anx (XML-based) answer files. Client information may be stored in <client>.anx answer files. Document class information may be stored in <document class>.anx or <profile>.anx (XML-based) answer files. Firm preferences may be stored in <preferences>.anx (XML-based) answer files. Such files may be accessed for use in subsequent forms and documents. Gathered information also may be stored in a database. The present invention may track time, date and user access information which also may be stored as metadata in files or in a database.

The software system is conceptually comprised of the following elements: a list of clients, matters and documents arranged and presented hierarchally in a software tree structure; interviews for gathering client, matter and document information; help text; business and legal commentary; and templates and forms. While the software content is platform independent, it must be programmed to run on a particular document assembly engine such as, but not limited to, HotDocs®. While most of the currently available engines are similar in design, some structural and syntactical differences exist.

Methodology

Law firms and other businesses have traditionally organized their work hierarchally by clients, matters and documents. Document managers, data managers, and billing software programs designed for law firms have almost universally adopted the client/matter/document (“CMD”) paradigm. Unlike prior art software, the present invention follows the CMD model which parallels traditional CMD workflow processes. By providing a more intuitive system and method, the need for training and support is reduced. Users thereby more efficiently use their time. A software wrapper, built around HotDocs®, is comprised of a number of components, all of which are novel in concept and design except for the Microsoft Access JET engine. The software components are: a graphical user interface (GUI) built on the CMD model; a CMD database which may be built with a Microsoft Access JET database; a resources manager; a preferences manager; a firm settings manager; a profile manager; a help manager; a security and administration manager; a customization manager; and a license manager.

File Management

In one embodiment of the invention, the CMD database and software application automatically name, save, and store HotDocs® answer files and final word processing documents. An internal file management mechanism provides insulation to the user from the native file naming and storing mechanism of HotDocs® which is the use of traditional file and folder data storage structures. The CMD database stores metadata about clients, matters, and documents (e.g. date item created, client number, matter information, document & answer file names) in the CMD database. Like a library, the CMD database tracks this information and provides a 128-bit global unique identifier (GUID) for the name of each answer file and document file. The software application, through the CMD database, automatically tracks the location of, and provides access to, these files. GUIDs are appropriate because they eliminate the possibility of duplicates and naming conflicts of files. GUIDs also provide the ability to track files off-line where files are checked out and checked in, much like books are handled at a library. In a checked out state, files are locked and cannot be further edited by other users. When files are checked in, the software system synchronizes the information in the files with the CMD database. With GUIDs, there is no concern about conflicting duplicate file or folder names. Thus, client and other data are not lost. In one embodiment, all answer files and client documents are stored in one directory. For example, a directory listing might appear like the listing in Table 1 where each file name is composed of a GUID and a file extension. In Table 1, a file extension of “.anx” is an answer file, and a file extension of “.rtf” is a document in rich text format.

TABLE 1
Directory listing of files

03f5f6a3-3aab-11d9-9669-0800200c9a66.anx
03f5f6a3-3aab-11d9-9669-0800200c9a67.anx
03f5f6a3-3aab-11d9-9669-0800200c9a68.rtf

The software application stores interview answers in XML answer files. The system is designed for one or more users. For workgroups, the software may maintain a single database on a shared server. The metadata, interview data, templates, interviews and documents can be accessed by all members of a workgroup with the appropriate access rights. In one embodiment, a CMD database is a JET Microsoft Access database. JET databases support fairly large datasets and accept most basic SQL commands. In another embodiment, a CMD database is any relational database (RDB).

Main User Interface

In one embodiment, the software system is a single document interface (SDI) where the software window or form may be referred to as a shell. In one embodiment, the shell is divided into four areas. There may be other software forms such as a login dialog. The shell makes software calls to internal as well as external software functions.

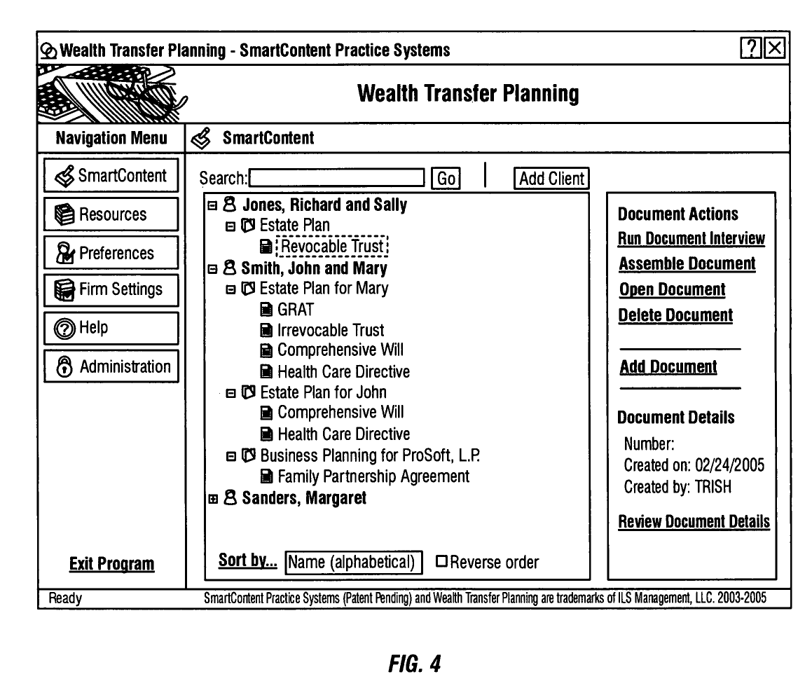

With reference to FIG. 4, in one embodiment, the top area 408 of the shell 430 is dedicated to branding. On the left is a navigation menu or menu bar 410, and in the middle is the work area 412. The navigation bar 410 is used to access the functions and resources within the software application by triggering switching events. In one embodiment, the menu in the navigation bar 410 is available regardless of where a user chooses to set the focus of the software application or what software function is being executed. In one embodiment, a navigation bar 410 is a simple one-level vertical button bar. As the mouse is dragged over a button, a hover color is applied to the selected button so a user sees where the mouse is positioned. When a button is clicked, it changes color. This type of behavior avoids confusion. Each navigation bar button has an icon which is duplicated in the title bar of a work area header 414 near the top of the shell to provide orientation to a user. In one embodiment, when a user first launches the software application, the form loaded into the work area 412 is a SmartContent form, which corresponds to, and may be selected by, the first button in the navigation bar 410 in FIG. 4. A SmartContent form contains data structures and logic which may trigger context sensitive information to appear, and which make available software functions and controls in a context-sensitive manner.

Within the work area 412 of the shell 430, there is a work area header 414 which provides orientation as a user accesses menu items in the navigation bar 410, and other functions. The information listed in the work area 412 may be read-only. The functions and controls available in the work area change as previously described in regard to SmartContent. Specifically, as particular data structures and software controls are accessed, different controls and content appear in the work area 412 and in the menu of the navigation bar 410.

At the bottom of the shell 430 is a status bar 416 which is dedicated to reporting program status and other information. The system reports the status of certain processing events. The status bar 416 continually appears at the bottom of the shell 430.

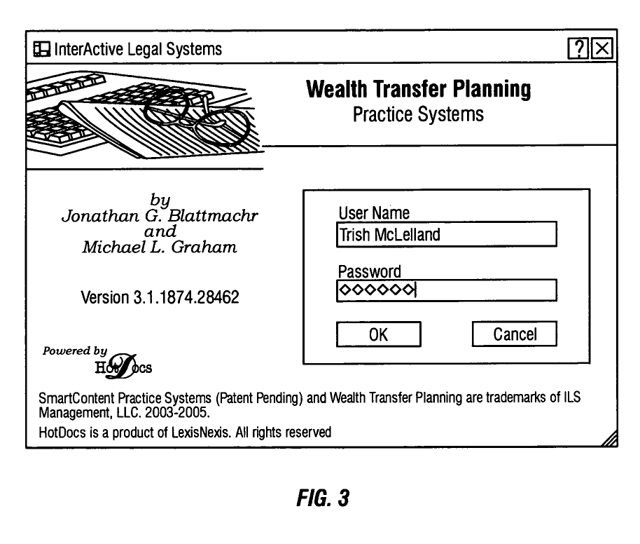

In one embodiment, at system startup, a login dialog is launched as shown in FIG. 3. This dialog requires that a user enter a user ID and password into the respective user ID 302 and password fields 304. Security checks are run on each user so that the application can respond based on the particular user's security rights. For example, if a user is not an administrator, an administration button on the navigation bar 410 will not be displayed.

When the user selects a button from the navigation bar 410 or a function from the work area 412, the shell 430 must switch the context sensitive functions 404 in the area on the right of the shell 430, and “snap in” the appropriate form into the work area 412 of the shell 430.

In one embodiment, some software functions launch a dialog or interview which is a collection of additional software forms which may contain fields for data entry. Some information in an interview is system generated and read only.

Content Management

The present invention provides access to, and organizes information about, clients, matters, and documents. In one embodiment, a SmartContent tree structure presents information in a hierarchal fashion and provides functions content-sensitively to a user as different entries within the data structure are selected. Specifically, different functions become available for documents, matters, and clients as each of these types of entries in the tree structure are selected. With reference to FIG. 4, a SmartContent tree structure 426 lists entries 402 from the CMD database and these entries can be sorted by a number of criteria. In one embodiment, one of these criteria is selected from a pick list 406 just above the status bar 416. Once an entry in the tree structure is selected, a series of context sensitive functions 404 become available for that entry in a list on the right side of the software form. For example, if a user clicks on a matter, he can copy a matter, delete it, or run a matter interview. These functions are listed in the area on the right hand side of the shell 430. As another example, if the “copy matter” is chosen, it can be used to create mirror image estate planning documents for a husband and wife by allowing the user to copy documents and matter answer files. Such efficient re-use of the same matter information is one of the benefits of the present invention.

Resources & Help Manager

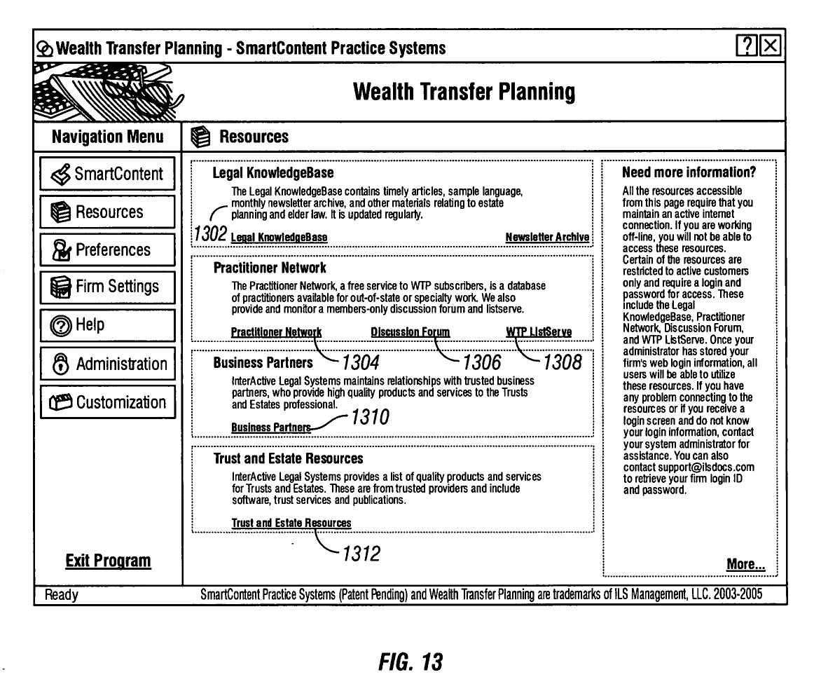

The present invention includes a resources manager which provides links to certain useful dynamic information accessible through the Internet. With reference to FIG. 13, in one embodiment, a resources manager provides a link to a legal knowledgebase 1302. A knowledgebase is a collection of helpful allied materials available to registered users through such link 1302. A resources manager may also provide a link to a practitioner network 1304, a link to an online discussion forum 1306, and a link to a listserv for a particular topic 1308. A resources manager may also provide a link to business partners 1310, and a link to other resources related to a particular practice module. For example, a resources manager may provide a link to other trust and estate resources 1312. The resources manager may provide links to other useful information. The dynamic information linked through a resources manager and residing on, and served from, a computer server device may be changed periodically to maximize the availability of current information about particular topics.

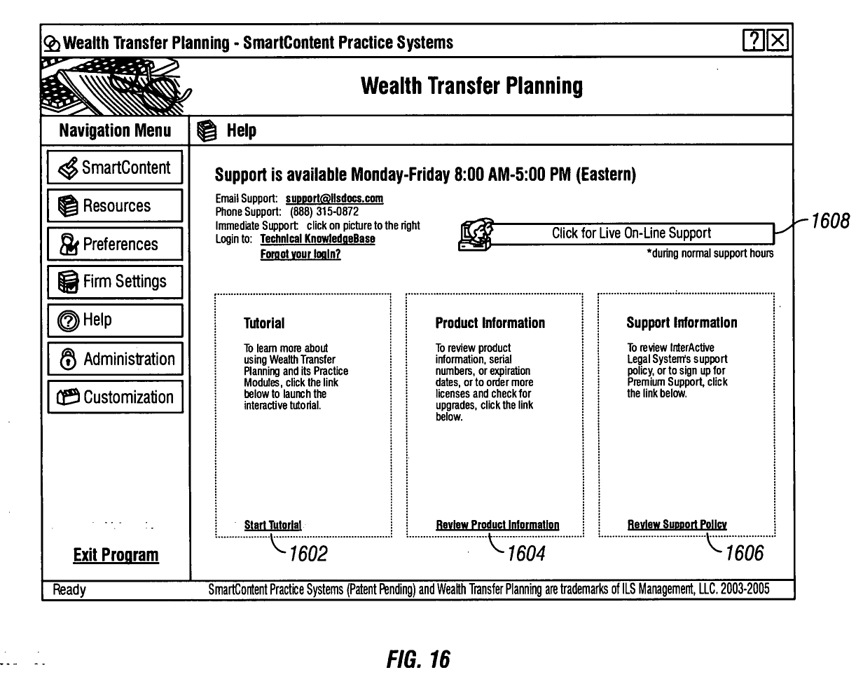

Similarly, a help manager provides a user with tutorial and other information. Similar to the resources manager, a help manager also provides links to various help resources through the Internet. For example, with reference to FIG. 16, a help manager provides a tutorial link 1602 to further information covering various practice modules. A user may also access more detailed product information through a product information link 1604. A user may also access additional product support information through a product support link 1606. In another embodiment, a user may be able to access live on-line support through a live support link 1608. Through such live support link 1608, a user may access a chat or other interactive support session whereby a human support staff member interacts with the user to answer a question or help solve a user's problem.

Preferences Manager

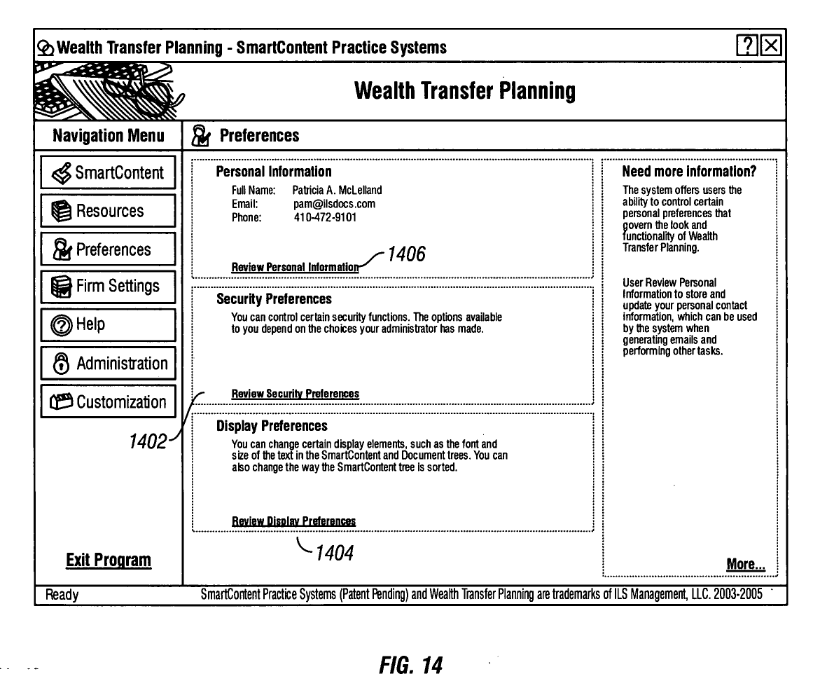

The present invention includes a preferences manager which provides a means to access and change the preferences of each system user. Access to change certain preferences must be granted by a user having administrator privileges. Software forms are presented to a privileged user who may then modify preference settings. FIG. 14 shows one embodiment of a preferences manager. With reference to FIG. 14, a privileged user has access to personal information about a particular software user. A privileged user may review and modify such personal information by selecting a review personal information link 1406 which provides access to additional forms where such modifications may be made. Additionally, a privileged user may select a security preferences link 1402 which launches subsequent forms which allow for changes to security settings for a particular user. Likewise, a privileged user may select a display preferences link 1404 which launches other subsequent forms which allow for changes to display settings for a particular user. Modifications to preference settings are stored in XML files.

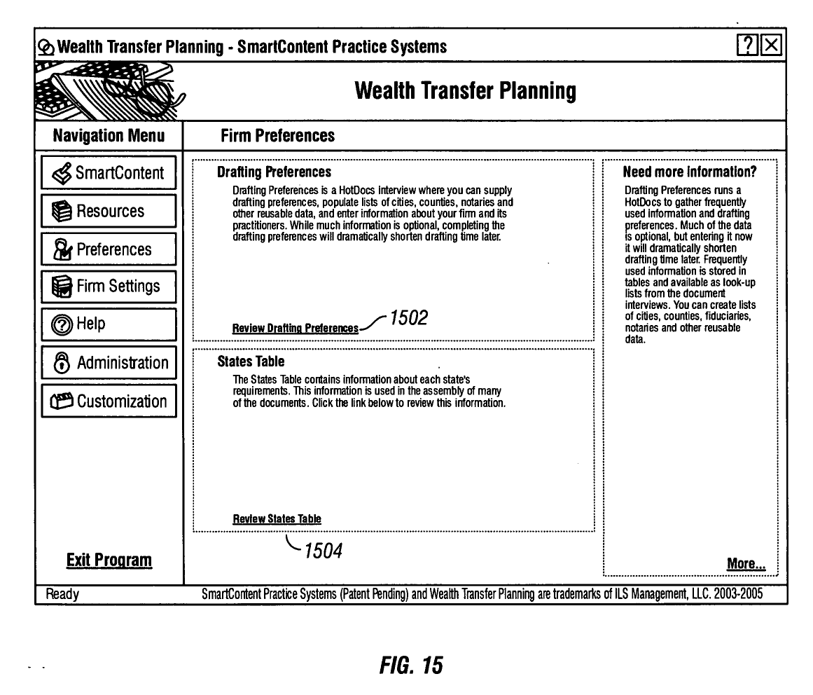

With reference to FIG. 15, the present invention also includes a firm settings manager which allows a privileged user to make changes to firm-wide settings. Such settings are global, system-wide preferences which serve as defaults for all users or an entire workgroup comprising a subset of users. A user may belong to one or more workgroups. In one embodiment, a firm-wide settings manager runs a HotDocs® interview designed to gather information about the firm, the employees, and document drafting preferences. A privileged user may access such interview through a review drafting preferences link 1502. A firm settings manager may also store and provide a means to modify information specific for each state. In one embodiment, a privileged user may access a states table through a states table link 1504 wherein state specific data is presented and may be modified. Settings from a preferences manager and a firm settings manager are stored in XML files.

Profile Manager

The present invention includes a profile manager which allows a user to select a document template and a HotDocs® pattern answer file or profile simultaneously. This profile manager combines two HotDocs® interface functions into one. The profile manager appears when the user clicks “Add Document,” and the templates and associated profiles appear in a hierarchical list, organized by topic. After a user selects an item from the profile manager, the software system is instructed to use a particular template and to run one or more HotDocs® overlay/underlay functions, which will copy data from a profile answer file into the current matter file. This functionality provides the user with a first set of default answers in documents.

Customization Manager

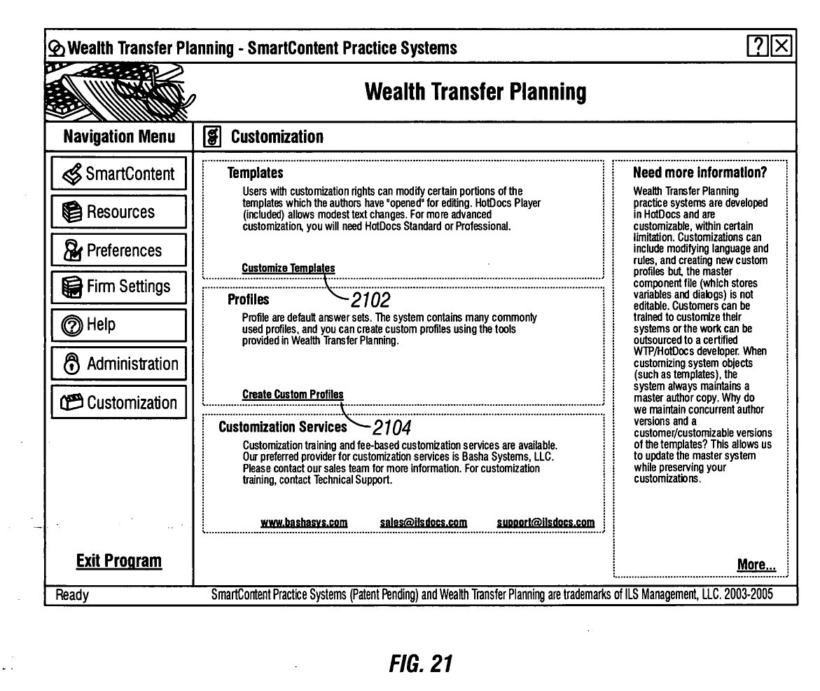

The present invention includes a customization manager which permits a user with customization rights to customize certain aspects of system templates and to add, maintain, and delete custom profiles. In one embodiment, and with reference to FIG. 21, a user with customization rights may access a link 2102 which grants access to subsequent software forms through which such user may customize document templates. The customization manager allows for many different types of changes to templates. For example, the customization manager allows changes to definite articles of templates. Likewise, a customization manager provides a custom profiles link 2104 which provides software forms to create, modify and manage profiles or default answer sets. Profiles or default answer sets are merged with templates to assemble a document. The customization manager allows such changes to be preserved despite software updates, hardware failures, and other events. Customization manager metadata is stored in proprietary XML files. The customized templates are stored in rich text format (RTF) files and custom profiles are stored in HotDocs® XML files.

Security & Administration Manager

The present invention includes a security and administration manager which stores user and administrator information, including particular settings and preferences, in XML files. A system administrator can assign rights to use individual practice systems to each software user, which provides the ability to internally manage user licenses. Administrators can also assign administrator rights (permitting access to the Administration Manager) and customization rights (permitting access to the Customization Manager). System administrators can perform several functions through the security and administration manager such as: add, maintain, and delete users; assign users to certain practice systems; assign user security rights; manage practice system licenses; access product updates; and run backup and restore functions.

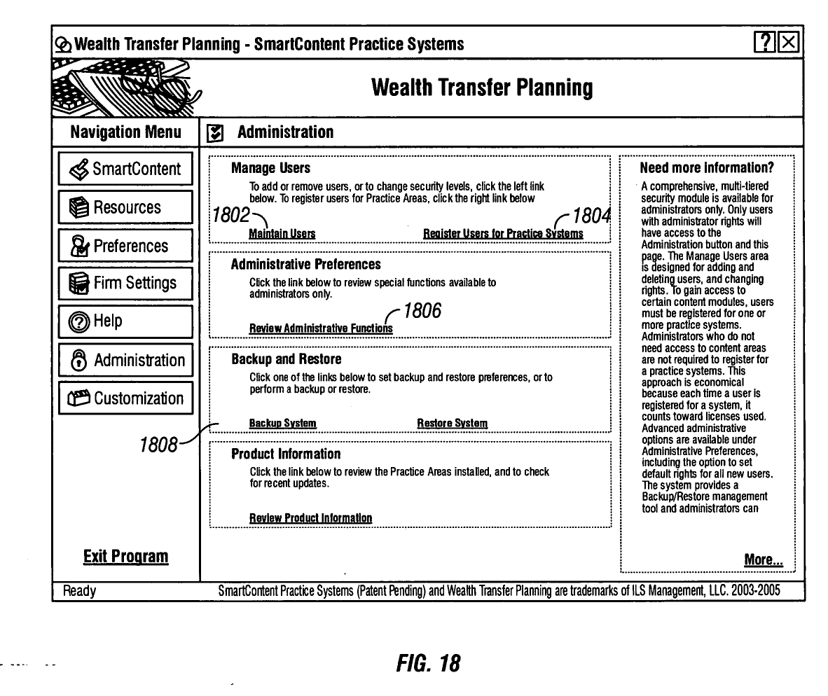

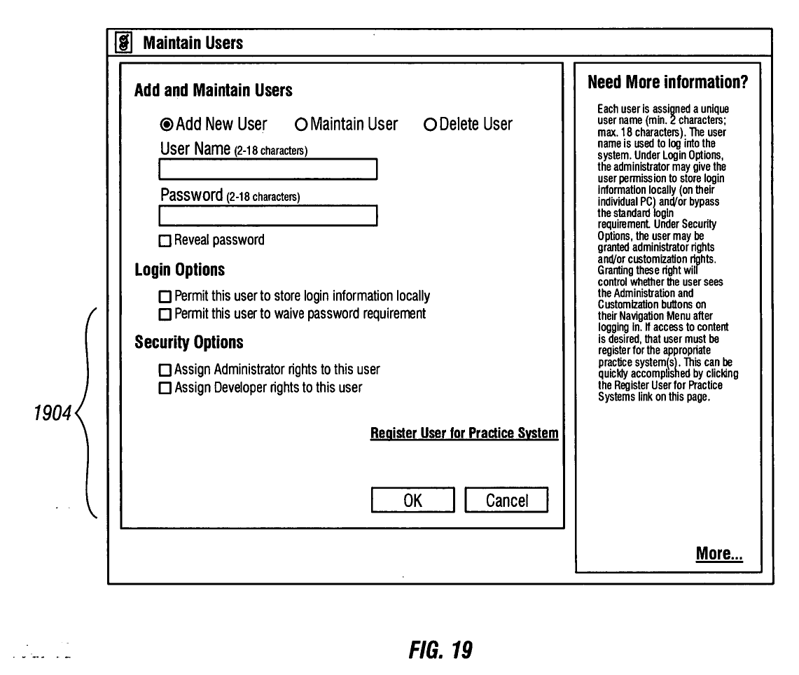

FIG. 18 shows one embodiment of an administration manager. In this embodiment, a privileged administrator may access and modify user information through additional software forms accessible through a maintain users link 1602. One such form to modify user information is shown in FIG. 19. With reference to FIG. 19, a privileged administrator may add a new user, maintain a user, or delete a user. A privileged administrator may also select certain options 1704 for a particular user through checkboxes. Such options may include allowing a user to store login information locally, permitting the user to waive the requirement to have a password, granting administrator rights to a user, and granting developer rights to a user.

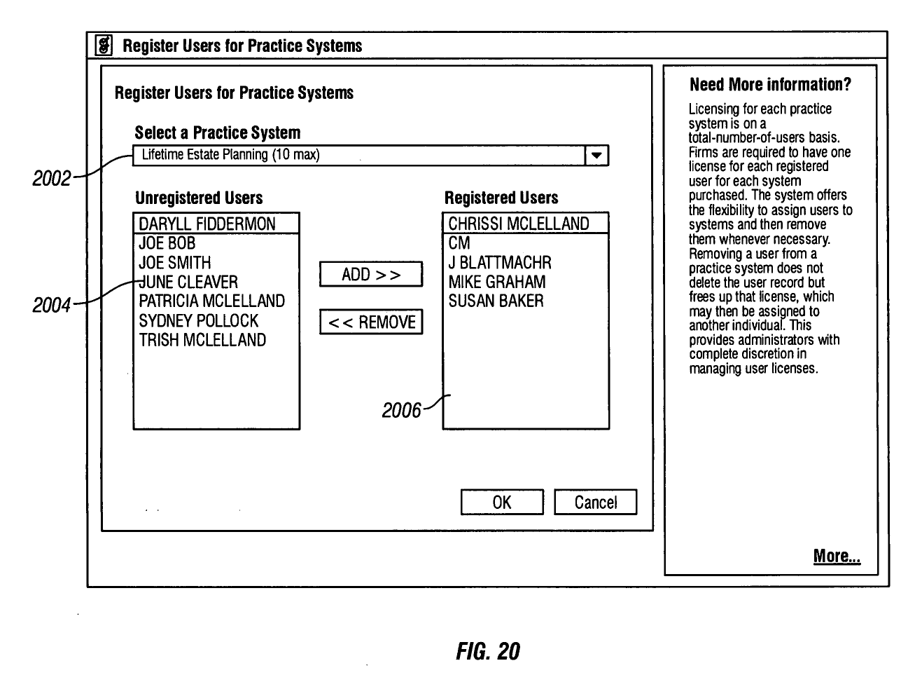

With reference to FIG. 18, a privileged administrator may also associate each user with one or more practice systems through a register users link 1604. Such association may be done through a form as shown in FIG. 20 or through another software means. With reference to FIG. 20, a privileged administrator may associate particular unregistered users 2004 with a particular practice system 2002 thereby making registered users 2006. Such users are then authorized to access clients, matters, templates and documents associated with the particular practice system 2002.

With reference to FIG. 18, a privileged administrator may also modify administrator settings of the software system. In one embodiment, such settings may be accessed through a review administrative functions link 1606. A privileged administrator may backup and restore system preferences. In one embodiment, a privileged administrator accesses these functions through a backup system link 1808, and a restore system link 1010, respectively. System preferences are stored in one or more XML files. Further, a privileged administrator may review product information including updates, news and other relevant information through a review product information link 1012.

License Manager

The present invention includes a license manager which is a software utility for managing access rights to certain practice systems of the software. The software and invention are made to work with multiple practice systems. There may be a different number of licenses for each practice system. For example, a firm may have six licenses, corresponding to six authorized users, to an estate planning practice system, but may have only two licenses to an elder law planning practice system. Each software application user is assigned to one or more practice systems by an authorized administrator.

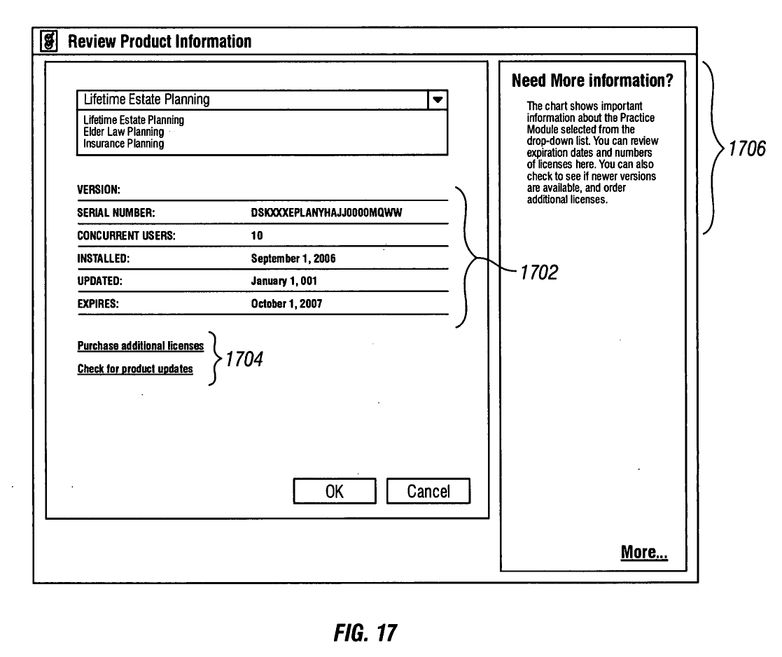

FIG. 17 shows one embodiment of a license manager form where information 1702 regarding a lifetime estate planning module is presented to an administrator. Such information may include the number of authorized users, installation date, and expiration date. A license manager also may provide practice system administration links 1704 through which an administrative user may purchase additional licenses and may check for product updates. In the license manager, and in other forms of the invention, additional, context sensitive information 1706 is presented to a user. Such information provides guidance to users.

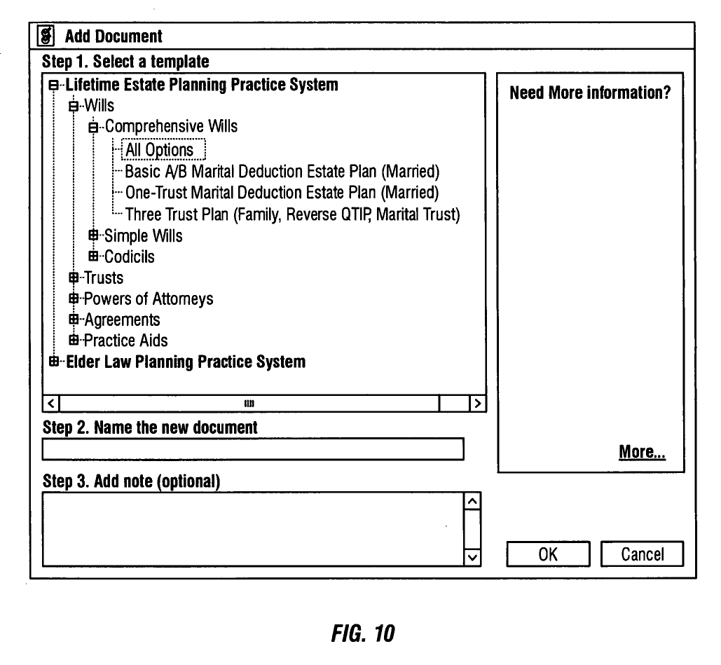

Once assigned to a practice system through a license manager, a user may only access client information, matter information, and document information which belong to a practice system for which the user is authorized. One embodiment of such restrictive access is illustrated in FIG. 4 and FIG. 10. With reference to FIG. 4, when a user attempts to add a new document through an add document dialog, a user will only be able to select or add documents to practice systems to which the user has access rights. With reference to FIG. 10, a user only has access to estate planning documents 1082 in the hierarchal document tree, and does not have access to elder law planning 1084. The elder law planning content tree 1084 in the Add Document Dialog is grayed out and is non-accessible such that a non-privileged user cannot select anything from that list.

Furthermore, there is additional security built into the entries 402 in a SmartContent tree structure as show in FIG. 4. In one embodiment, if a user is not authorized, all documents belonging to a practice system are grayed out and are not accessible. For example, a user may have access only to estate planning. In such a SmartContent tree list for John Smith, there may be a matter which includes a Medicaid trust. Since the user does not have access to an elder law practice system, the Medicaid trust will be grayed out and non-accessible in the Client/Matter/Document list and the user will not be able to run the corresponding functions such as an HD Interview, assemble, or delete on that document.

In another embodiment, a license manager may also control licenses based on a subscription model where products will cease to function at the end of a subscription period unless renewed. A subscription model is particularly effective for users in professions such as the legal profession where certain language is time sensitive and may become obsolete such as when laws are repealed, superseded or changed. Each practice system may have different periods of renewal and different periods for renewal reminders. In one embodiment, once a renewal reminder period has begun (e.g. 60 days before expiration), a counter is added to the interface, showing a user the remaining number of days in the subscription. Once a license has expired for a particular practice system, a grace period may be provided. In one embodiment, a 30 day grace period is given. At the expiration of a license, and an optional grace period, users will no longer be able to access documents belonging to expired practice systems.

Document Assembly

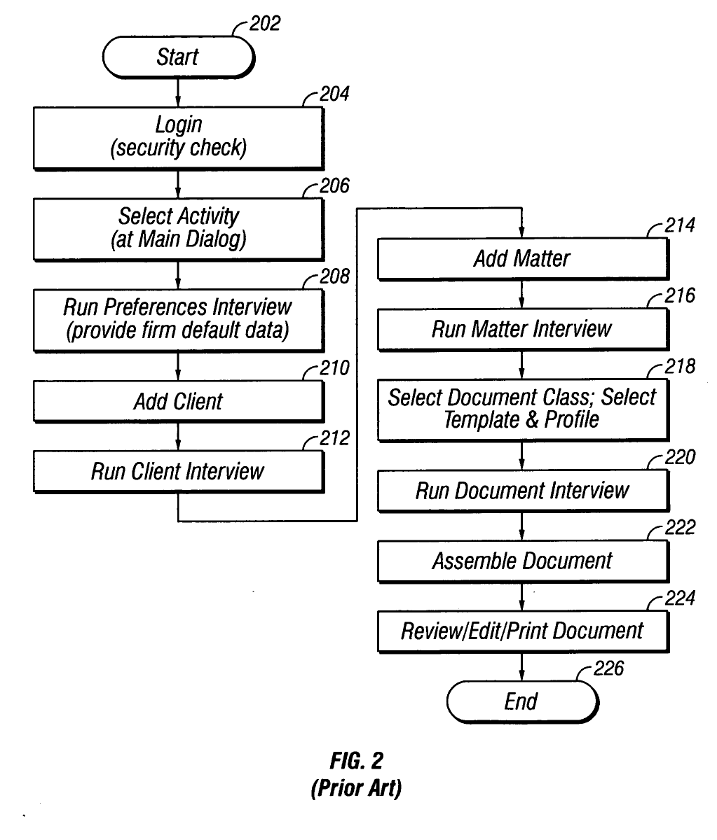

One embodiment of the document assembly method according to the present invention is outlined in FIG. 2. With reference to FIG. 2, a user starts 202 the document assembly process by first entering authorization credentials through a login or security dialog 204. Next, a user selects an activity 206. In a preferred embodiment, a user first runs a firm-wide preferences interview 208 which sets some default information for the software application. In a typical scenario, such a preferences interview 208 is only run one time. Next, a user may add a new client record 210 or may select an existing client record through a software interface. A user subsequently runs a client interview 212 in which the user is allowed to add additional information about the client through one or more software forms. The software presents document-specific prompts and input fields which aid the user in storing information for completing an array of various documents associated with the particular client. The information may be stored in a database residing on a computer system, or other hardware or software means, and the information is associated or connected to the client's record for later use. In one embodiment, the information is stored in a Microsoft Access database. Other databases may be used.

With reference again to FIG. 2, after a client interview is run, a matter record may be added 214. Next, a matter interview 216 may be run; matter information may be gathered and stored in a database. A user may then select a document class 218 and thereby add a document class record to a particular matter which is hierarchally associated with a particular client. Along with selecting a document class, a user selects a template and profile 218 to use for the particular document class. At this point, a user may run a document interview 220 before finally assembling a document 222. A user may then review, edit and print a document 224 before ending 226 the document assembly process or method according to the present invention.

By entering client information first, according to the inventive method, any number of assembled documents may be subsequently created wherein fields in the templates for client information are automatically populated with client information. Similarly, a user may also enter matter information and generated documents automatically may be populated with matter information. A software embodiment practicing such method provides improved efficient re-use of client information.

FIGS. 4-12 show embodiments of a software interface in which a user may gather information and assemble a document according to the present invention and the method described in FIG. 2. FIG. 4 illustrates the main user interface of a client centric software interface from which most tasks are executed. Such interface differs from the prior art in that a client and corresponding client record 402, and not a document type, is the paradigm of document assembly. In FIG. 4, a firm settings interview may be launched by selecting the appropriate button found in the menu bar 410 on the left side of the shell 430.

FIG. 5 shows one embodiment of a firm settings interview. In this embodiment, and other similar interviews, HotDocs® is called and used to gather information. With reference to FIG. 5, a firm settings interview allows a user to provide new firm information or modifying existing firm information which may be used in assembling a document. Such information may be accessed and collected on one or more software forms. In one embodiment, firm settings are organized by conceptual groupings. A user may access firm settings by selecting an appropriate entry in a menu structure 502 or menu tab 508. Firm settings may include document default options which may be selected as check boxes 504, as pulldown pick menus 506, or any other software means including user input fields. In one embodiment, the firm preferences are stored in one or more answer files. The name of such files may be shown in a file name field 510; a user may be able to edit or select the name of firm preference answer files. FIG. 5 corresponds to step 208 in FIG. 2.

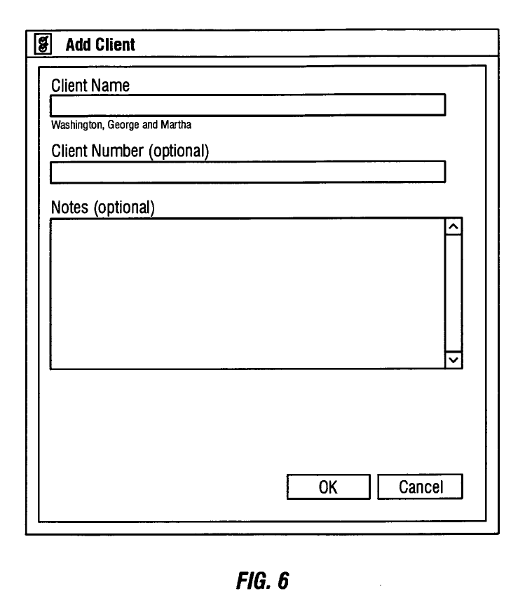

In FIG. 4, a user is given the option of selecting an existing client, or creating a new client, through an add client button 424 or other software means. When a user adds a new client, a form or dialog such as the one shown in FIG. 6 may be launched. A user adds a client by entering a client name into a client name field 602, and may add optional client information such as a client number and client notes in a respective client number field 604 and client note field 606. Once a client name is entered, a user may confirm the addition of a client into the software system through a software button or other means; such confirmation closes the add client dialog. FIG. 6 corresponds to step 210 in FIG. 2.

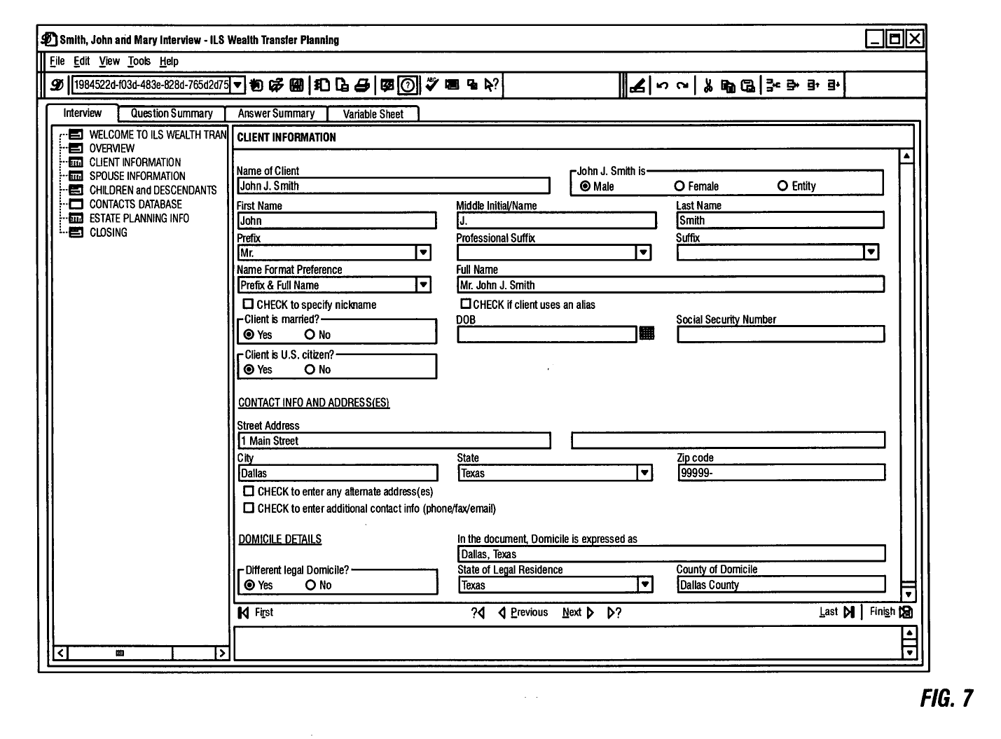

Once a user selects a client entry 402 in the main software form such as the one shown in FIG. 4, a user may initiate a client interview. One embodiment of a client interview is shown in FIG. 7. With reference to FIG. 7, a user is given the option of providing new client information or modifying existing client information through user input fields, radio buttons, check boxes, and other software means similar to those shown in the firm preferences interview of FIG. 5. In FIG. 7, the user is given the option of completing fields for client information such as, but not limited to, name, street address, date of birth, U.S. citizenship, Social Security number, number of children, and a myriad number of other such details. Client information and corresponding software elements are arranged and organized into conceptual groupings as in FIG. 5. A user may similarly access, and navigate to, forms through selection of menu entries in a menu structure 502 or menu tab 508, or through buttons 512 or other software means. Once a user is finished entering or modifying client information, the client interview information is stored in one or more answer files named according to a GUID string. The name of such answer files may be shown in a name field 510. FIG. 7 corresponds to step 212 in FIG. 2.

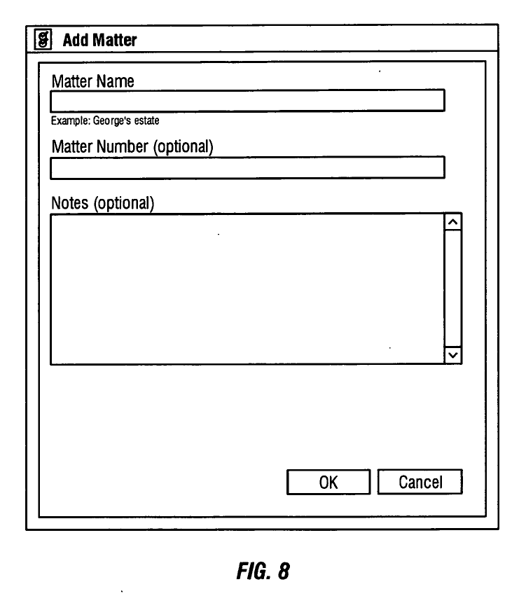

Once a client is selected and client information is entered into the system, a user may select the type of document to generate through a document class dialog such as the embodiment shown in FIG. 8. Such dialog is very similar to an add client dialog of FIG. 6. An add matter dialog allows a user to enter a matter name into a matter name field 802, and optional matter number and matter notes into corresponding software fields 804, 806.

Once a user enters a matter for a client, a user launches a matter interview from the main software form such as the one shown in FIG. 4. One embodiment of a matter interview is shown in FIG. 9. With reference to FIG. 9, a user may select options and enter information specific to the particular matter. A user may navigate to other forms for such options by selecting an appropriate entry in a menu structure 502 or menu tab 508. Matter settings may be selected as check boxes 504, as pulldown pick menus 506, or any other software means including user input fields. In one embodiment, the matter settings or preferences are stored in one or more answer files. The name of such files may be shown in a file name field 510; a user may be able to edit or select the name of matter preference answer files. FIG. 9 corresponds to step 216 in FIG. 2.

FIG. 10 illustrates one embodiment of a software dialog to select a document class and enter a new document name for a new document associated under a given matter; such dialog corresponds to step 218 of FIG. 4. In this step, there are sub-steps. First, and with reference to FIG. 10, a user selects a template by selecting an appropriate entry in a software tree structure 1020. A user accesses the tree 1020 by selecting a practice system 1002, and then by selecting a specific document category 1004. For example, a document category may be a will, trust or other document class belonging to an estate planning practice group. Subsequently, a user selects a subcategory 1006 and then a specific document class or type 1008 to be added to a matter. For example, in FIG. 10, an “all options” document class 1008 is selected under the subcategory of comprehensive wills 1006. In a second sub-step, a user enters a name for the new document in a document name field 1010 and optionally adds document notes in a notes field 1012. Upon the user's acknowledgement through a button 1014 or other software means, the software dialog enters a new document record 422 under a particular matter 420 which is hierarchally associated with a particular client record 402 in the SmartContent tree structure 426 as shown in FIG. 4. The new document record has the document name given by the user and is of a type selected as the document template in the first sub-step.

In one embodiment using HotDocs®, at the time the new document entry 422 is made, the system handles three processes simultaneously. It first associates the correct template with the document entry 422, selects a corresponding document answer file, and overlays or merges the corresponding matter answer file with a default document answer file. Ordinarily, this is separate steps in HotDocs® and other document assembly systems. Such automation is more efficient and reduces the likelihood for technical and legal errors. Further document specific information is captured in the system by executing a document interview.

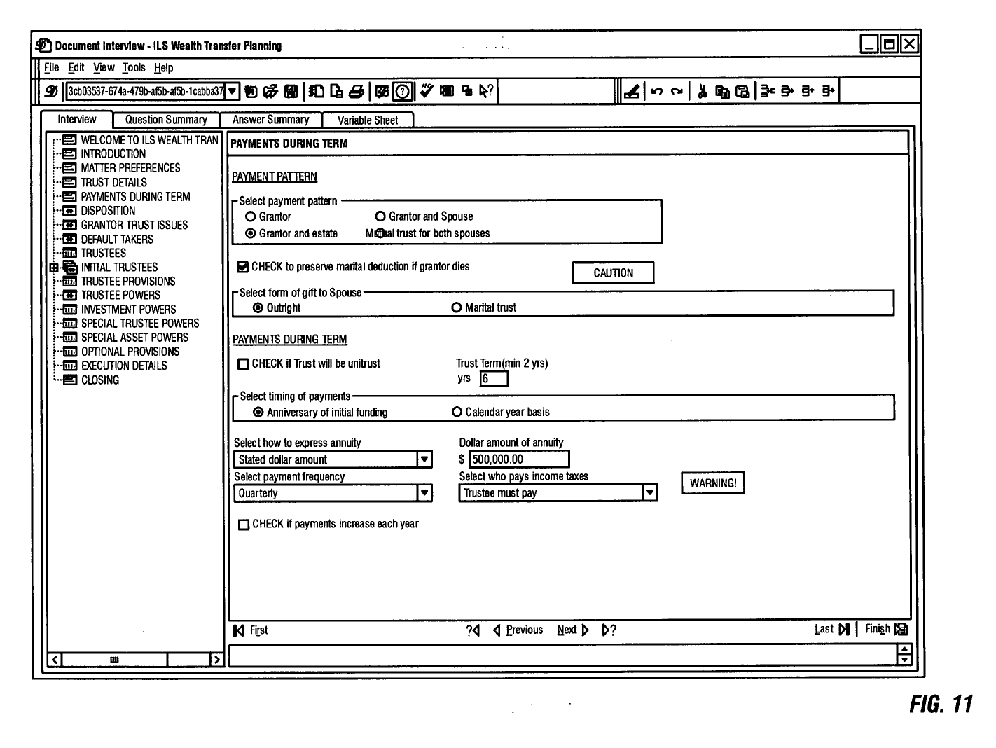

Once a new document entry 422 is made, a user may run a document interview corresponding to step 220 in FIG. 2 by selecting the corresponding context sensitive function 404 in the main user interface shown in FIG. 4. One embodiment of a document interview is shown in FIG. 11. With reference to FIG. 11, a user may select options and enter information specific to the particular document template or type. Like in the other interview forms, a user may navigate to other forms for such options by selecting an appropriate entry in a menu structure 502 or menu tab 508. Matter settings may be selected as check boxes 504, as pulldown pick menus 506, or any other software means including user input fields. In one embodiment, the document information is stored in one or more document answer files. The name of such files may be shown in a corresponding file name field 510; a user may be able to edit or select the name of document answer files.

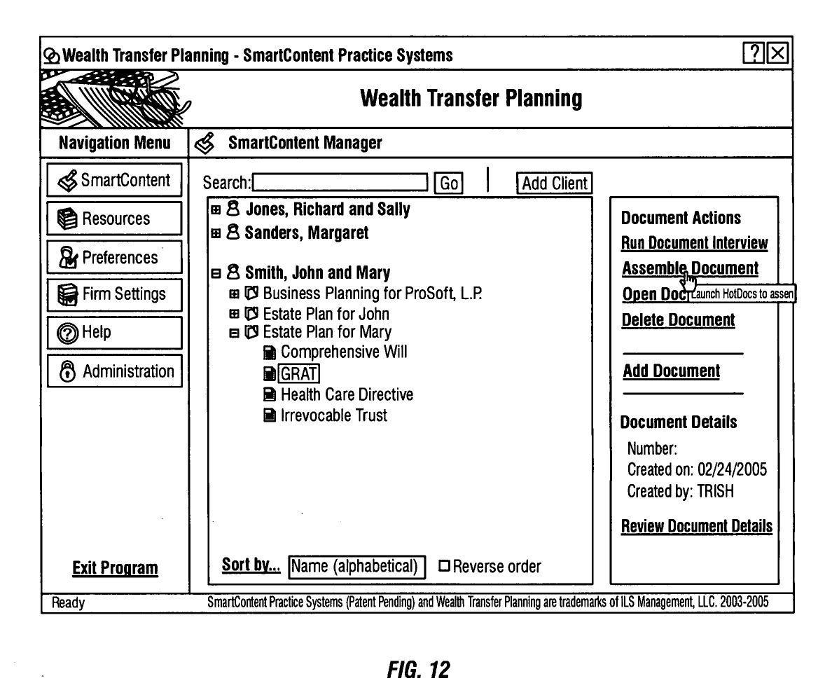

With reference to FIG. 2, at the conclusion of a document interview 220, a user has captured client, matter and document information which subsequently may be reused in other documents created from templates having matching data fields. At this point, a user may assemble a document corresponding to step 222 in FIG. 2 by selecting the corresponding context sensitive function 404 in the main user interface shown in FIG. 4 and FIG. 12. With reference to FIG. 12, no dialog or interview is required to complete such task. However, a progress, status or other indicator may be displayed to a user as a document is assembled. In one embodiment, assembly of a document is the formation of a new document from merging a copy of a template file with information from a document answer file and other answer files such as client and matter answer files. An assembled document may then be opened for review, editing, and printing corresponding to step 224 in FIG. 2.

Alternatively, and in another embodiment, through a smart document dialog, multiple documents can be selected and assembled as a package. Such documents can be electronically stored together. One advantage of forming packages of documents is that changes made to one document are automatically propagated into other documents in the same package. Information about documents and the associated package is stored in a software means such as a database.

In another embodiment, a user may not opt to perform a document interview. However, a document assembled with just client information, or client and matter information, may be missing information. Such information must be manually entered into a document at the editing step 224 of the document assembly process illustrated in FIG. 2 and such information is not captured in the system.

FIG. 4 shows the selection of a document entry 402 in a tree software structure 424. Available context sensitive functions, which may be performed on a document record, are shown on the right side of the shell 430 in a context sensitive menu 404. In one embodiment, a user may perform several functions or actions 414 on a document such as run a document interview, assemble a document, open a document, or delete a document.

Modifications to any of the information associated with each of the records for clients, matters, or documents are persisted in a database. Database records may be arranged according to a hierarchal fashion first according to client, then according to matter, and then according to document. A user may create, update, and delete information in the database through a software interface. The software interface and database allow for the efficient re-use of client and other information in the assembly of documents.

The foregoing discussion of the invention has been presented for purposes of illustration and description. Further, the description is not intended to limit the invention to the form disclosed herein. Consequently, variation and modification commensurate with the above teachings, within the skill and knowledge of the relevant art, are within the scope of the present invention. The embodiment described herein and above is further intended to explain the best mode presently known of practicing the invention and to enable others skilled in the art to utilize the invention as such, or in other embodiments, and with the various modifications required by their particular application or uses of the invention. It is intended that the appended claims be construed to include alternate embodiments to the extent permitted.

We claim:

1. A client centric document assembly system for creation and manipulation of computer formatted documents with minimal user input, the system comprising:
a computer processing means for processing data;
an interface means for allowing a user to input client specific information, matter specific information, and document specific information;
a first means for generating question and answer dialogs to elicit client specific information, matter specific information, and document specific information from the user;
a data storage means for storing data in a hierarchical fashion on a storage medium, wherein said data storage means is organized hierarchically to maintain said client specific information, said matter specific information relative to said client specific information, and said document specific information relative to said matter specific information;
a second means for storing said elicited information in said storage means in a hierarchical fashion, said client specific information stored in a client record, said matter specific information stored in a matter record relative to said client record, and said document specific information stored in a document record relative to said matter record; and
a third means for retrieving said elicited information from said storage means with minimal user input and assembling a document from previously stored said client specific information, said matter specific information relative to said client specific information, and said document specific information relative to said matter specific information.

2. The client centric document assembly system of claim 1 further comprising a fourth means for managing the number of users that may concurrently access the system.

3. The client centric document assembly system of claim 1 wherein said interface means allows a system administrator to administer said client centric document assembly system.

4. The client centric document assembly system of claim 3 wherein said interface means allows a system administrator to administer user access privileges to said client centric document assembly system.

5. The client centric document assembly system of claim 1 wherein said data storage means is a relational database.

6. The client centric document assembly system of claim 1 wherein said first and said second means are a document assembly software engine that generates question and answer dialogs to interact with said user through said interface means to compose said client, said matter, and said document information into uniquely identified, user manipulable files for proper hierarchical storage in said data storage means.

7. The client centric document assembly system of claim 1 wherein said third means is a document assembly software engine that generates documents from previously stored said client record, said matter record relative to said client record, and said document record relative to said matter record.

8. The client centric document assembly system of claim 1 wherein said computer processing means and said data storage means are attached via a network.

9. A document assembly method using the client centric document assembly system of claim 1, the method comprising:
a. generating, with said first means, question and answer dialogs to elicit user input regarding client specific information;
b. entering, with said interface means, client specific information in response to said question and answer dialogs;
c. capturing, with said second means, said client specific information in a client record for storage in said data storage means;
d. generating, with said first means, question and answer dialogs to elicit user input regarding matter specific information relative to said captured client specific information;
e. entering, with said interface means, matter specific information in response to said question and answer dialogs;
f. capturing, with said second means, said matter specific information in a matter record for storage in said data storage means structured to hierarchically maintain said matter record relative to said client record;
g. generating, with said first means, question and answer dialogs to elicit user input regarding document specific information;
h. entering, with said interface means, document specific information in response to said question and answer dialogs;
i. capturing, with said second means, said document specific information in a document record, for storage in said data storage means structured to hierarchically maintain said document record relative to said matter record;
j. generating, with said third means, a complete document by retrieving from said storage means said client record, said matter record relative to said client record, and said document record relative to said matter record;
k. repeating steps d through f as necessary to input and capture additional matter specific information for said client specific information;
l. repeating steps g through i as necessary to input additional document specific information for said matter specific information; and
m. generating, with said third means, additional complete documents as necessary by automatically retrieving from said data storage means said matter record relative to said document record, and said client record relative to said matter record without the need for the user to re-enter client or matter specific information.

10. A document assembly method using the client centric document assembly system of claim 3, the method comprising:
a. generating, with said first means, question and answer dialogs to elicit user input regarding client specific information;
b. entering, with said interface means, client specific information in response to said question and answer dialogs;
c. capturing, with said second means, said client specific information in a client record for storage in said data storage means;
d. generating, with said first means, question and answer dialogs to elicit user input regarding matter specific information relative to said captured client specific information;
e. entering, with said interface means, matter specific information in response to said question and answer dialogs;
f. capturing, with said second means, said matter specific information in a matter record for storage in said data storage means structured to hierarchically maintain said matter record relative to said client record;
g. generating, with said first means, question and answer dialogs to elicit user input regarding document specific information;
h. entering, with said interface means, document specific information in response to said question and answer dialogs;
i. capturing, with said second means, said document specific information in a document record, for storage in said data storage means structured to hierarchically maintain said document record relative to said matter record;
j. generating, with said third means, a complete document by retrieving from said storage means said client record, said matter record relative to said client record, and said document record relative to said matter record;
k. repeating steps d through f as necessary to input and capture additional matter specific information for said client specific information;
l. repeating steps g through i as necessary to input additional document specific information for said matter specific information;
m. generating, with said third means, additional complete documents as necessary by automatically retrieving from said data storage means said matter record relative to said document record, and said client record relative to said matter record without the need for the user to re-enter client or matter specific information; and
n. managing, with said interface means, said system configuration and administration information.

11. A document assembly method using the client centric document assembly system of claim 4, the method comprising:
a. generating, with said first means, question and answer dialogs to elicit user input regarding client specific information;
b. entering, with said interface means, client specific information in response to said question and answer dialogs;
c. capturing, with said second means, said client specific information in a client record for storage in said data storage means;
d. generating, with said first means, question and answer dialogs to elicit user input regarding matter specific information relative to said captured client specific information;
e. entering, with said interface means, matter specific information in response to said question and answer dialogs;
f. capturing, with said second means, said matter specific information in a matter record for storage in said data storage means structured to hierarchically maintain said matter record relative to said client record;
g. generating, with said first means, question and answer dialogs to elicit user input regarding document specific information;
h. entering, with said interface means, document specific information in response to said question and answer dialogs;
i. capturing, with said second means, said document specific information in a document record, for storage in said data storage means structured to hierarchically maintain said document record relative to said matter record;
j. generating, with said third means, a complete document by retrieving from said storage means said client record, said matter record relative to said client record, and said document record relative to said matter record;
k. repeating steps d through f as necessary to input and capture additional matter specific information for said client specific information;
l. repeating steps g through i as necessary to input additional document specific information for said matter specific information;
m. generating, with said third means, additional complete documents as necessary by automatically retrieving from said data storage means said matter record relative to said document record, and said client record relative to said matter record without the need for the user to re-enter client or matter specific information;
n. managing, with said interface means, said system configuration and administration information; and
o. managing, with said interface means, said user access privileges.
